(19) United States
(12) Patent Application Publication
(10) Pub. No.: US 2007/0086801 A1
(43) Pub. Date: Apr. 19, 2007

(54) Image forming apparatus

(75) Inventors: Shingo Sakato, Osaka (JP); Ai Takagami, Osaka (JP); Eiji Nimura, Osaka (JP); Hiroyuki Hamakawa, Osaka (JP); Yoshinori Horiuchi, Osaka (JP); Masashi Fujishima, Osaka (JP)

Correspondence Address: SMITH, GAMBRELL & RUSSELL, 1850 M STREET, N.W., SUITE 800, WASHINGTON, DC, 20036, US

(73) Assignee: KYOCERA MITA CORPORATION

(21) Appl. No.: 11/546,892

(22) Filed: Oct. 13, 2006

(30) Foreign Application Priority Data
Oct. 17, 2005 (JP) 2005-301298
Jan. 31, 2006 (JP) 2006-021810

(51) Int. Cl. G03G 15/02; G03G 15/06

(52) U.S. Cl. 399/50; 399/55

(57) ABSTRACT

In an image forming apparatus, a control section 41 adjusts the surface potential of a photoconductor or the developing potential of a developer carrying member based on the detection result of a surface potential sensor 44, and performs first correction whereby, relative to the reference value of the applied bias of a charger 2 or the developing bias of the developer carrying member in a developing unit 4 as observed during potential adjustment, the applied bias or the developing bias is varied so as to keep constant the potential difference between the surface potential of the photoconductor and the developing potential of the developer carrying member during image formation. The control section also performs second correction whereby the applied bias or the developing bias is restored to the reference value over a predetermined period after the completion of continuous image formation.

This application is based on Japanese Patent Application No. 2005-301298 filed on Oct. 17, 2005 and Japanese Patent Application No. 2006-21810 filed on Jan. 31, 2006, the contents of which are hereby incorporated by reference.

### BACKGROUND OF THE INVENTION

1. Field of the Invention

The present invention relates to an electrophotographic image forming apparatus incorporating a photoconductor, and more particularly to a method of stabilizing the potential on the surface of the photoconductor or the developing potential of a developer carrying member.

2. Description of Related Art

The construction of the image forming section of a conventional image forming apparatus is shown in FIG. 15. In FIG. 15, along the direction of rotation (indicated by arrow A) of a photoconductor drum 1, the image forming section 15 is fitted with a charger 2, an exposure unit 3, a developing unit 4, a transfer roller 5, a scrubbing roller 6, a cleaning blade 9 and a charge eliminating unit 10. The photoconductor drum 1, for example, has a photoconductive layer of amorphous silicon (a-Si) formed on an aluminum drum, and the charger 2 charges the surface of the photoconductor drum. An electrostatic latent image is then formed on the surface of the photoconductor drum as a result of a laser beam from the exposure unit 3 hitting it so as to remove charges therefrom. The charger 2 charges the surface of the photoconductor drum 1 by electric discharge (for example, corona discharge) through the application of a high voltage via an electrode such as a thin wire.

The exposure unit 3 shines a light beam (for example, a laser beam) on the photoconductor drum 1 according to image data so as to form an electrostatic latent image on the surface of the photoconductor drum 1. The developing unit 4 is provided with a developing sleeve 4a (developer carrying member) that is so arranged as to face the photoconductor drum 1. A toner stored inside the developing unit is attached to the electrostatic latent image on the photoconductor drum 1 by the developing sleeve 4a to form a toner image.

As known in the art, after the charge eliminating unit 10 eliminates charges, an electrostatic latent image is recorded by the exposure unit 3 on the photoconductor drum 1 that is evenly charged by the charger 2, then the electrostatic latent image is made visible as a toner image by the developing unit 4 through reversal development, and then the toner image is transferred to a sheet 11 by the transfer roller 5. The part of the toner left untransferred by the transfer roller 5 is removed as a residual toner from the surface of the photoconductor drum 1 by the scrubbing roller 6 and the cleaning blade 9, and the residual toner thus removed is conveyed to an unillustrated disposal bottle by a toner collecting unit such as a collecting screw 8.

Reference numeral 14 represents a cleaning unit that is provided with: the scrubbing roller 6 and the cleaning blade 9, both of which serve together as a polishing system for polishing the photoconductor drum 1; and a spring 7 that presses the scrubbing roller 6 onto the surface of the photoconductor with a predetermined force. The scrubbing roller 6 is, for example, formed as a shaft covered with urethane foam rubber, and is rotated by an unillustrated motor with a predetermined linear velocity difference maintained with respect to the circumferential velocity of the photoconductor drum 1. Used as an abrasive toner is one having an abrasive, such as titanium oxide, strontium titanate or alumina, embedded in the surface of toner particles so as to be held to partly protrude from the surface thereof, or one having an abrasive electrostatically attached to the surface thereof.

In the image forming apparatus described above, discharge products, such as ozone, NO_{X} and SO_{X}, which are generated by electric discharge from the wire of the charger, attach to the surfaces of the shield and the grid of the charger. These discharge products are insulators under a low-humidity environment, and thus increase the resistance of the grid. This breaks the balance of electric discharge between the charger and the photoconductor drum, increasing the potential on the surface of the photoconductor.

On the other hand, the discharge products are soluble in water so that, when the humidity inside the apparatus increases, the discharge products attached to the grid dissolve. Thus, the grid turns back conductive as it inherently is. In actual image formation, since a sheet of paper contains a small amount of water, water vapor is formed when the sheet passes through a high-temperature fixing unit. This water vapor causes the humidity inside the apparatus to gradually increase, and therefore the discharge products attached to the grid dissolve, decreasing back the surface potential of the photoconductor.

Such variations in the surface potential are not likely to occur in image forming apparatuses such as low- and medium-speed image forming apparatuses that do not require a large amount of electric discharge or in image forming apparatuses that have relatively short maintenance cycles. However, in the case of image forming apparatuses that are designed to offer high speed printing capability and long maintenance cycles so as to meet the recent demands for high-speed and maintenance-free operation, as the amount of attached discharge products increases, variations in the surface potential becomes remarkable. The variations in the surface potential vary the potential difference between the surface potential and the developing potential of the developer carrying member that supplies a developer to the surface of the photoconductor. Disadvantageously, this significantly affects image quality such as color reproducibility in low-density portions and in a color copier.

Under this background, there have been proposed methods for preventing degradation of image quality through correction of the surface potential of a photoconductor during image formation. For example, according to the method disclosed in JP-A-H05-323743, a latent image pattern is formed on part of a photoconductor with a predetermined surface potential and a predetermined amount of light exposure to memorize a reference surface potential, and then, at the time of image formation, a latent image pattern is formed under the same conditions to detect the actual surface potential so that the amount of light exposure, the amount of charge and the developing bias potential are corrected based on the difference between the detected value and reference value.

For another example, according to the method disclosed in JP-B-3217584, the surface potential of at least either a dark or bright portion is detected during continuous image formation, then the target correction values of the grid voltage and the developing direct current bias are determined based on the detected value, and then the grid voltage and the developing direct current bias are corrected stepwise toward the target correction values during image formation so as to reach the target correction values after images have been formed on a predetermined number of sheets.

After the completion of image formation, the discharge products described above turn back non-conductive as the humidity inside the apparatus decreases. This increases the resistance of the grid again, and thus increases the surface potential of the photoconductor. By the methods disclosed in JP-A-H05-323743 and JP-B-3217584, however, whereas the surface potential is corrected during image formation, no further correction is performed after the completion of the image formation. Thus, when an image is formed again after time has passed, the increase in the surface potential attributable to correction during the previous image formation is augmented by the increase in the surface potential attributable to the decrease in humidity. Disadvantageously, this causes the surface potential to increase more than it initially does. Thus, extremely low-density images are outputted until the potential correction performed during image formation produces the expected effect. One way to overcome these disadvantages is to adjust the surface potential before each round of image formation. This method is, however, undesirable in that a waiting period for the adjustment of the surface potential before each round of image formation is remarkably long.

### SUMMARY OF THE INVENTION

In view of the disadvantages described above, it is an object of the present invention to provide an image forming apparatus that can reduce variations in the potential difference between the surface potential of a photoconductor and the developing potential of a developer carrying member without reducing the efficiency of image processing so as to form high-quality images.

To achieve the above object, according to the present invention, an image forming apparatus is provided with an image forming section and control means. The image forming section includes: a photoconductor; a scorotron-type charger that evenly charges the surface of the photoconductor; an exposure unit that writes an electrostatic latent image on the surface of the photoconductor; and a developing unit that attaches toner to the surface of the photoconductor by use of a developer carrying member to form a toner image according to the electrostatic latent image. The control means varies the potential difference between the surface potential of the photoconductor and the developing potential of the developer carrying member by adjusting at least one of the applied bias of the charger and the developing bias of the developer carrying member. Here, the present invention is characterized in that the control means performs first correction whereby at least one of the applied bias and the developing bias is corrected from a predetermined reference value so as to keep the potential difference constant during continuous image formation, and also performs second correction whereby the bias corrected in the first correction is restored to the reference value over a predetermined period after the completion of the continuous image formation.

With this construction, it is possible to keep constant the potential difference between the surface potential of the photoconductor and the developing potential of the developer carrying member by gradually restoring at least one of the applied bias and the developing bias to the reference value over a predetermined period even if, after water-soluble discharge products attached to the grid of the charger have dissolved due to an increase in the humidity during image formation, the discharge products turn back non-conductive as the humidity decreases after the completion of the image formation and thus the surface potential of the photoconductor restores to the value of the surface potential as observed before the start of the image formation. Thus, it is possible to realize an image forming apparatus that can form images with proper density at all times.

According to the present invention, the image forming apparatus constructed as described above is further provided with surface potential detecting means that detects the surface potential of the photoconductor. Here, the control section performs the potential adjustment to set the reference value with predetermined timing based on the detection result of the surface potential detecting means, and also performs the first correction based on the detection result of the surface potential detecting means during continuous image formation.

With this construction, it is possible to set the reference value corresponding to the actually measured value of the surface potential even if the humidity environment around the apparatus changes with weather, the installation location of the apparatus and the like. During continuous image formation, it is also possible to effectively perform the correction according to actual variations in the surface potential by carrying out the first correction based on the detection result of the surface potential.

According to the present invention, the image forming apparatus constructed as described above performs the first correction involves determining a bias correction amount based on the average of the surface potentials of the photoconductor as detected during inter-sheet periods for a predetermined number of sheets and then increasing or decreasing at least one of the applied bias and the developing bias by the bias correction amount.

With this construction, it is possible to correct the potential difference between the surface potential of the photoconductor and the developing potential of the developer carrying member to an optimal value by gradually varying the applied bias or the developing bias from the reference value as the grid becomes increasingly conductive during the continuous image formation.

According to the present invention, the image forming apparatus constructed as described above performs the first correction during inter-sheet periods after the inter-sheet periods for a predetermined number of sheets have elapsed after the continuous image formation was started until the continuous image formation is completed or until the surface potential of the photoconductor stops varying.

With this construction, it is possible to adjust the grid applied bias or the developing bias accurately to the optimal value for every one-sheet worth image formation.

According to the present invention, the control means in the image forming apparatus constructed as described above performs the potential adjustment at start-up or on return from a standby mode, and also performs the second correction such that the bias corrected in the first correction is restored to the reference value as set in the immediately preceding potential adjustment.

With this construction, it is possible to restore at least one of the applied bias and the developing bias to the newest reference value at all times. This makes it possible to correct the surface potential more accurately.

According to the present invention, the image forming apparatus constructed as described above is further provided with printed sheet counting means that counts the total number of printed sheets. Here, the reference value is set for at least one of the applied bias and the developing bias based on an initially set value thereof and the number of printed sheets as counted from the initial state of the apparatus.

With this construction, it is possible to correct the surface potential or the developing potential accurately because the reference value is set in consideration of temporal variations in the gird resistance as the number of printed sheets is increased. The first correction is performed with a reference value that has previously been calculated by carrying out a simulation or the like. This helps reduce a burden on the control means to allow rapid processing. Furthermore, it is possible to perform the correction of the surface potential or the developing potential by setting the reference value without the use of an expensive surface potential sensor or the like. This helps reduce the cost of the image forming apparatus.

According to the present invention, the control means in the image forming apparatus constructed as described above completes the first correction when the applied bias or the developing bias reaches the initially set value thereof during image formation.

With this construction, it is possible to avoid the first correction being performed continuously even after the surface potential has stopped increasing. This makes it possible to reduce undue correction without the use of a surface potential sensor or the like.

According to the present invention, the image forming apparatus constructed as described above is further provided with humidity detecting means that detects the humidity inside the apparatus. Here, based on the number of printed sheets as counted from the initial state of the apparatus and the detection result of the humidity detecting means, at least one of a correction amount per unit period in the first correction and a period for which to perform the second correction is determined.

With this construction, it is possible to correct the surface potential more accurately for variations therein and also to further enhance the accuracy of the surface potential and developing potential for the immediately succeeding round of printing even if the humidity environment around the apparatus changes with weather, the installation location of the apparatus and the like. This makes it possible to form higher quality images stably.

According to the present invention, the control means in the image forming apparatus constructed as described above interrupts the second correction and then performs image formation and the first correction when a next round of image formation is requested before the completion of the second correction.

With this construction, it is possible to perform the correction accurately even when a next round of image formation is requested while the surface potential of the photoconductor is being restored to the value thereof as observed before the start of image formation.

### BRIEF DESCRIPTION OF THE DRAWINGS

FIG. 1 is a schematic cross-sectional view showing the overall construction of an image forming apparatus according to the present invention;

FIG. 2 is a block diagram showing the configuration of the image forming apparatus of a first embodiment of the present invention;

FIGS. 3A and 3B are timing charts showing how the surface potential is corrected during continuous image formation and after the completion of the image formation in the image forming apparatus of the first embodiment;

FIGS. 4A, 4B and 4C are timing charts in a case where the correction amount of the gird voltage is determined based on the average of the surface potentials detected during the inter-sheet periods for the immediately preceding three sheets in the first correction;

FIGS. 5A and 5B are timing charts in a case where the gird voltage is linearly varied in the surface potential correction shown in FIGS. 3A and 3B;

FIGS. 6A and 6B are timing charts showing another example of how the surface potential is corrected during continuous image formation and after the completion of the image formation in the image forming apparatus of the first embodiment;

FIG. 7 is a flowchart showing how the image forming apparatus of the first embodiment operates;

FIG. 8 is a flowchart showing the process of determining the correction amount based on the average of the surface potentials detected during the inter-sheet periods for a predetermined number of immediately preceding sheets in the first correction;

FIG. 9 is a block diagram showing the configuration of the image forming apparatus of a second embodiment of the present invention;

FIGS. 10A, 10B and 10C are timing charts showing how the surface potential is corrected during continuous image formation and after the completion of the image formation in the image forming apparatus of the second embodiment;

FIG. 11 is a flowchart showing how the image forming apparatus of the second embodiment operates;

FIG. 12 is a block diagram showing the configuration of the image forming apparatus of a third embodiment of the present invention;

FIGS. 13A, 13B and 13C are timing charts showing how the surface potential is corrected during continuous image formation and after the completion of the image formation in the image forming apparatus of the third embodiment;

FIG. 14 is a flowchart showing how the image forming apparatus of the third embodiment operates; and

FIG. 15 is a schematic diagram showing the construction of the image forming section of a conventional image forming apparatus.

### DETAILED DESCRIPTION OF PREFERRED EMBODIMENTS

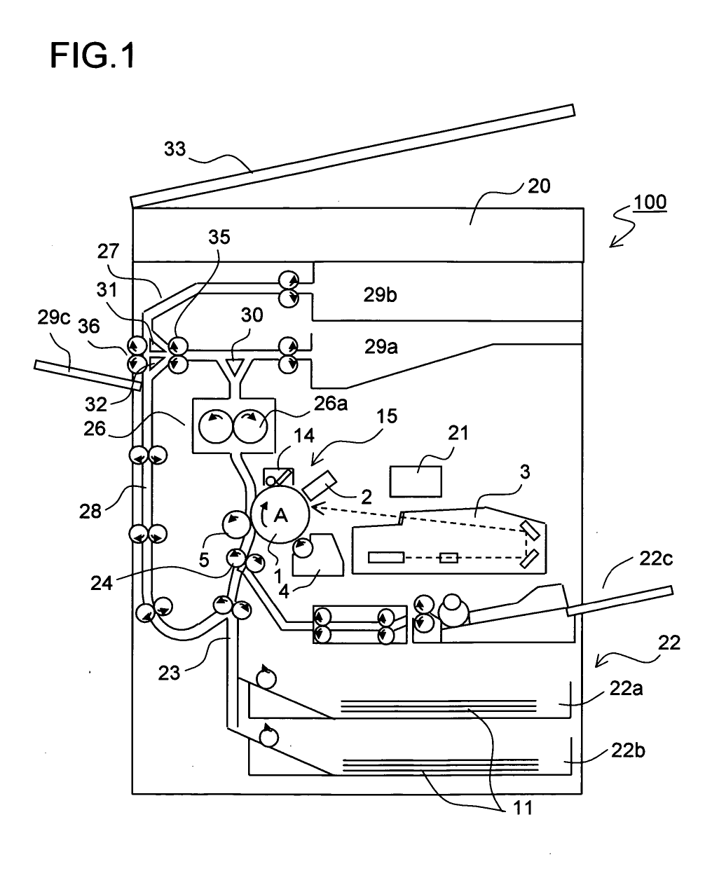

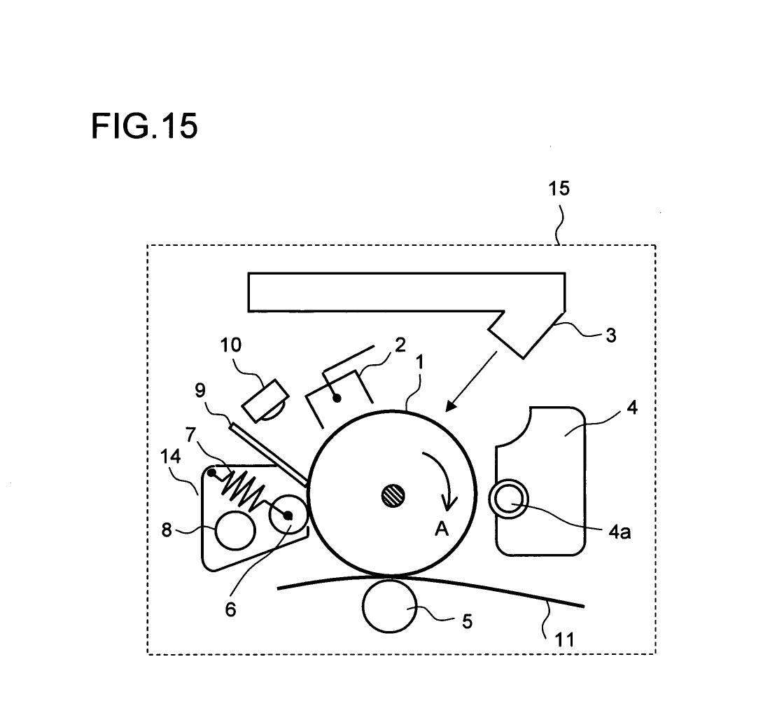

Hereinafter, embodiments of the present invention will be described with reference to the accompanying drawings. FIG. 1 is a schematic cross-sectional view showing the construction of an image forming apparatus embodying the present invention. Such parts as are found also in the conventional example shown in FIG. 15 are identified with common reference numerals, and no description thereof is repeated. In FIG. 1, reference numeral 100 represents an image forming apparatus, exemplified here by a digital multifunctional apparatus.

When the image forming apparatus 100 performs a copying operation, in an image forming section 15 inside the main body of the multifunctional apparatus, an electrostatic latent image is formed based on original image data read by an image input section 20, and toner is then attached to the electrostatic latent image by a developing sleeve 4a in a developing unit 4 to form a toner image. The toner is supplied to the developing unit 4 from a toner container 21. Then, the image forming apparatus 100 performs an image forming process with respect to a photoconductor drum 1 while it is rotated clockwise (in the direction indicated by arrow A) as shown in FIG. 1. The image forming process is the same as in the conventional example shown in FIG. 15, and therefore no description thereof is repeated.

Toward the photoconductor drum 1 having the toner image formed thereon as described above, a sheet 11 is conveyed from a paper feed mechanism 22 via a sheet conveying passage 23 and a pair of resist rollers 24 to the image forming section 15, where the toner image on the surface of photoconductor drum 1 is transferred to the sheet 11 by a transfer roller 5. The sheet 11 having the toner image transferred thereto is then separated from the photoconductor drum 1, and is then conveyed to a fixing section 26 having a pair of fixing rollers 26a, where the toner image is fixed.

The sheet 11 having passed through the fixing section 26 is directed to one of a plurality of sheet conveying passages 27 by passage switching mechanisms 30, 31 and 32 that have a plurality of passage switching guides provided at the branch points of the sheet conveying passages 27. The sheet 11 is then ejected directly (or after being conveyed to a sheet conveying passage 28 so as to have images formed on both sides thereof) into a sheet ejecting section composed of a first, a second, and a third ejecting tray 29a, 29b and 29c.

A charge eliminating unit 10 (see FIG. 15) serving to eliminate residual charges on the surface of the photoconductor drum 1 is provided to the downstream side of the cleaning unit 14. The paper feed mechanism 22 is provided with: a plurality of paper feed cassettes 22a and 22b that accommodate stacks of sheets 11 and that are detachably attached to the main body of the multifunctional apparatus; and a stack bypass (hand-feed tray) 22c formed thereabove. These all leads via the sheet conveying passage 23 to the image forming section 15 that includes the photoconductor drum 1 and the developing unit 4. Reference numeral 33 represents a platen (an original document holding member) that presses and thereby holds an original document onto the image input section 20.

Specifically, the sheet conveying passage 27 first branches into right and left passages at the downstream side of the pair of fixing rollers 26a, and one of them (the passage that branches rightward in FIG. 1) leads to the first ejecting tray 29a. The other passage (the passage that branches leftward in FIG. 1) then branches via a pair of conveying rollers 35 into up and down passages, and one of them (the passage that branches upward in FIG. 1) leads to the second ejecting tray 29b.

In contrast, the other passage (the passage that branches downward in FIG. 1) branches into two passages at a position immediately below the branch point mentioned above. Through one of the passages, the sheet 11 is ejected via a pair of ejecting rollers 36 onto the third ejecting tray 29c. The other passage leads to the sheet conveying passage 28. Through the sheet conveying passage 28, a sheet 11 with an image formed on only one side thereof is switched back and conveyed so that another image is then formed by the image forming section 15 on the other side of the sheet (two-sided copy). The sheet is then ejected.

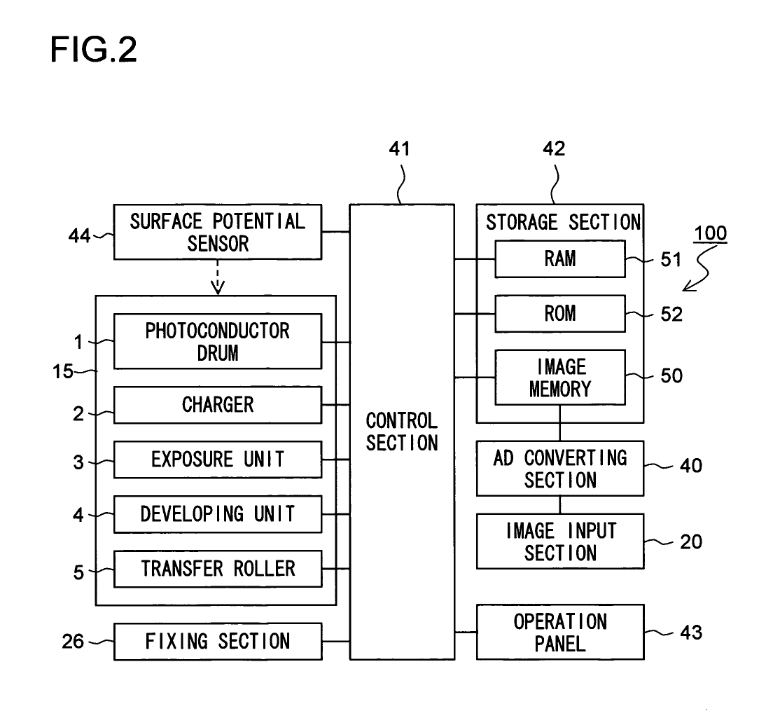

FIG. 2 is a block diagram showing the configuration of the image forming apparatus of a first embodiment of the present invention. Such parts as are found also in FIG. 1 are identified with common reference numerals. The image forming apparatus 100 includes the image forming section 15, the image input section 20, an AD converting section 40, a control section 41, a storage section 42, an operation panel 43, a surface potential sensor 44, and other components.

In a case where the image forming apparatus 100 is a copier as shown in FIG. 1, the image input section 20 is an image reading section that is composed of: a scanning optical system that includes a scanner lamp that illuminates an original document at the time of copying and mirrors that deflect the optical path of the reflected light from the original document; a condenser lens that focuses the reflected light from the original document to form an image; a CCD that converts the thus focused image light into electrical signals; and other components. In a case where the image forming apparatus 100 is a printer, the image input section 20 serves as a receiving section that receives image data transmitted from a personal computer or the like. An image signal inputted via the image input section 20 is fed to the control section 41, where image processing such as gradation processing is performed as required. The image signal is then converted into a digital signal in the AD converting section 40, and is then fed to an image memory 50, which will be described later, included in the storage section 42.

The image forming section 15 is composed of the photoconductor drum 1, a charger 2, an exposure unit 3, the developing unit 4, the transfer roller 5, and other components. The image forming section 15 forms an electrostatic latent image on the photoconductor drum 1 based on image data that is subjected to conversion in the AD converting section 40 and then stored in the image memory 50. The photoconductor drum 1, the transfer roller 5, the fixing roller 26a (see FIG. 1) within the fixing section 26, and the like are driven to rotate by a main motor (unillustrated), and the control section 41 transmits a control signal to the main motor to control the rotation and stopping of the photoconductor drum 1, the transfer roller 5, the fixing roller 26a, and the like.

The control section 41 comprehensively controls the image input section 20, the image forming section 15, the fixing section 26 and the like according to a preset program, and converts the image signal inputted via the image input section 20 into image data after performing scaling processing and gradation processing thereon as required. The exposure unit 4 shines laser light on the photoconductor drum 1 according to the processed image data to form an electrostatic latent image thereon. Moreover, the control section 41 controls the charger 2, the exposure unit 3, the developing unit 4 and the like in the image forming apparatus according to the preset program.

The storage section 42 includes the image memory 50, a RAM 51 and a ROM 52. The image memory 50 stores the image signal that is inputted in the image input section 20 and is then digitized in the AD converting section 40, and then feeds it to the control section 41. The RAM 51 and the ROM 52 store processing programs, processed data, and the like for the control section 41. They store reference values (to be described later) for the applied bias or developing bias when the surface potential of the photoconductor drum 1 is adjusted, and also store correction control programs (to be described later) for the applied bias or the developing bias during and after image formation.

The operation panel 43 is composed of: an operating section that is made up of a plurality of operation keys; and a display section that displays set conditions, the condition of the apparatus, and the like (neither of these sections is shown). The operation panel 43 is used when a user sets printing conditions and the like, and, for example in a case where the image forming apparatus 100 has a facsimile capability, it is also used to make various settings such as for storing facsimile transmission destinations in the storage section 42, reading and modifying the so stored destinations, etc.

The surface potential sensor 44 detects the surface potential of the photoconductor drum 1 with predetermined timing such as when the power to the apparatus is turned on or when the apparatus is restored from a standby mode, and the detection result is then sent to the control section 41. Based on the detection result, the control section 41 varies the applied bias that is applied to the charger 2 or the developing bias that is applied to the developing unit 4 so as to adjust to optimal values the surface potential of the photoconductor drum 1 or the developing potential of the developing unit 4. Here, the control section 41 stores the applied bias or developing bias at that point as a reference value in the RAM 51 included in the storage section 42.

This embodiment is characterized in that two kinds of correction are performed. In one of them, the surface potential of the photoconductor is adjusted based on the detection result from the surface potential sensor 44, and simultaneously, based on the reference value, which is the applied bias value or the developing bias value as detected when the surface potential is adjusted, the applied bias or the developing bias is varied so as to make constant the potential difference between the surface potential of the photoconductor and the developing potential during image formation (hereinafter referred to as “first correction”). In the other kind of correction, after the completion of continuous image formation, the applied bias or the developing bias is restored to the reference value over a predetermined period (hereinafter referred to as “second correction”).

Thus, during image formation, it is possible to correct to an optimal value the potential difference between the surface potential of the photoconductor drum 1 and the developing potential of the developing sleeve 4a by gradually varying the applied bias or the developing bias from the reference values as the grid becomes increasingly conductive with an increase in humidity; on the other hand, after the completion of the image formation, it is possible to keep constant the potential difference, regardless of the timing of image formation, between the surface potential of the photoconductor drum 1 and the developing potential of the developing sleeve 4a at all times by gradually restoring the applied bias or the developing bias to the reference value as the resistance of the grid increases.

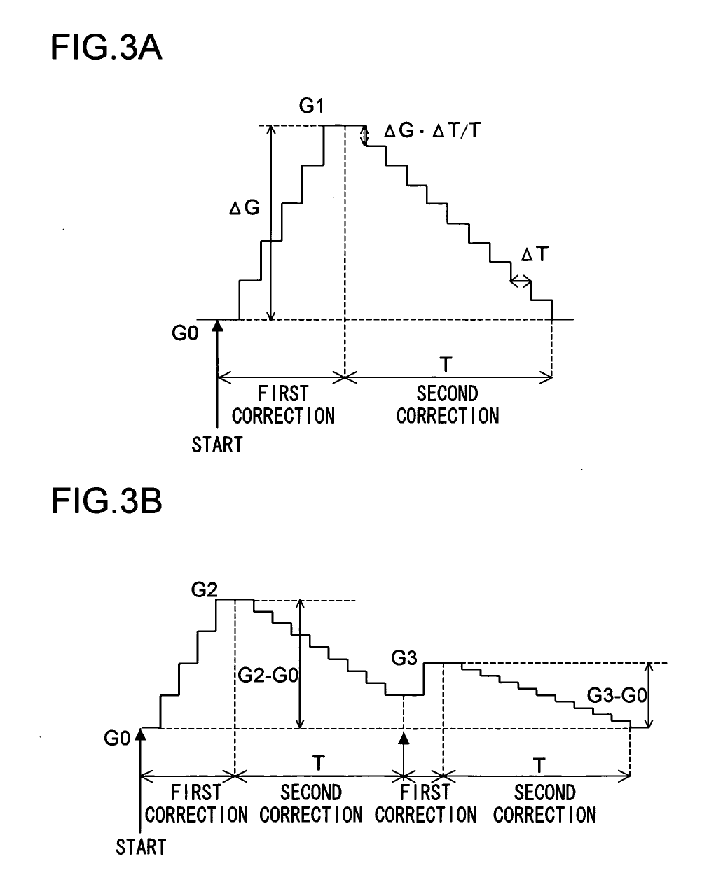

FIGS. 3A and 3B are timing charts showing how the surface potential is corrected during continuous image formation and after the completion of the image formation in the image forming apparatus of the first embodiment. How the correction is actually controlled will be described more specifically with reference to FIGS. 2, 3A and 3B. Here, a description will be given of, as an example, a case where the surface potential is adjusted by varying the grid voltage of the charger 2.

G0 represents the grid voltage observed when the surface potential is adjusted with predetermined timing such as when the power to the apparatus is turned on or when the apparatus is restored from a standby mode, and the grid voltage is stored as a reference value in the storage section 42. Here, the surface potential is adjusted based on the actually measured value thereof as detected by the surface potential sensor 44, and, whenever the surface potential is adjusted anew, its reference value in the storage section 42 is updated with the most recently measured grid voltage.

When image formation is started, the resistance of the grid decreases with an increase in humidity and thus the surface potential of the photoconductor drum 1 decreases. Thus, the surface potential sensor 44 detects the surface potential in periods (hereinafter referred to as “inter-sheet periods”) that fall between printing periods and during which no sheet is conveyed so that, based on the detection result, the control section 41 performs the first correction, whereby the grid voltage is gradually increased from the reference value G0 to G1 as shown in FIG. 3A. The first correction may be performed immediately after the start of image formation, or may be performed after a predetermined number of sheets has been printed.

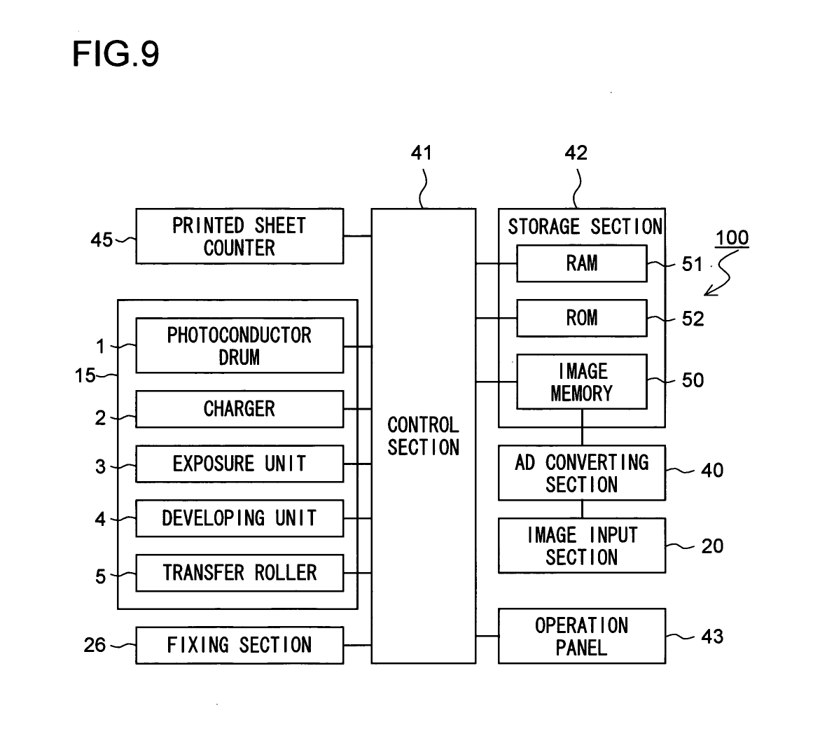

The first correction may be performed based on the individual detection result of the surface potential that is detected for every one-sheet-worth image formation by the surface potential sensor 44. It is, however, preferable that a printed sheet counter 45 (see FIG. 9) for counting the total number of printed sheets be provided so that the first correction is performed based on the average of such individual detection results of the surface potential detected for a plurality of sheets so as to enhance the detection accuracy. Here, the control may be such that first the grid voltage is corrected based on the average of the individual surface potentials detected for a predetermined number of sheets and then the average of the individual surface potentials for another predetermined number of sheets is calculated anew starting with the succeeding inter-sheet period. In this case, however, the first correction is performed for each of a plurality of sheets. This makes it impossible to adjust the grid voltage to an optimal value for every one-sheet-worth image formation.

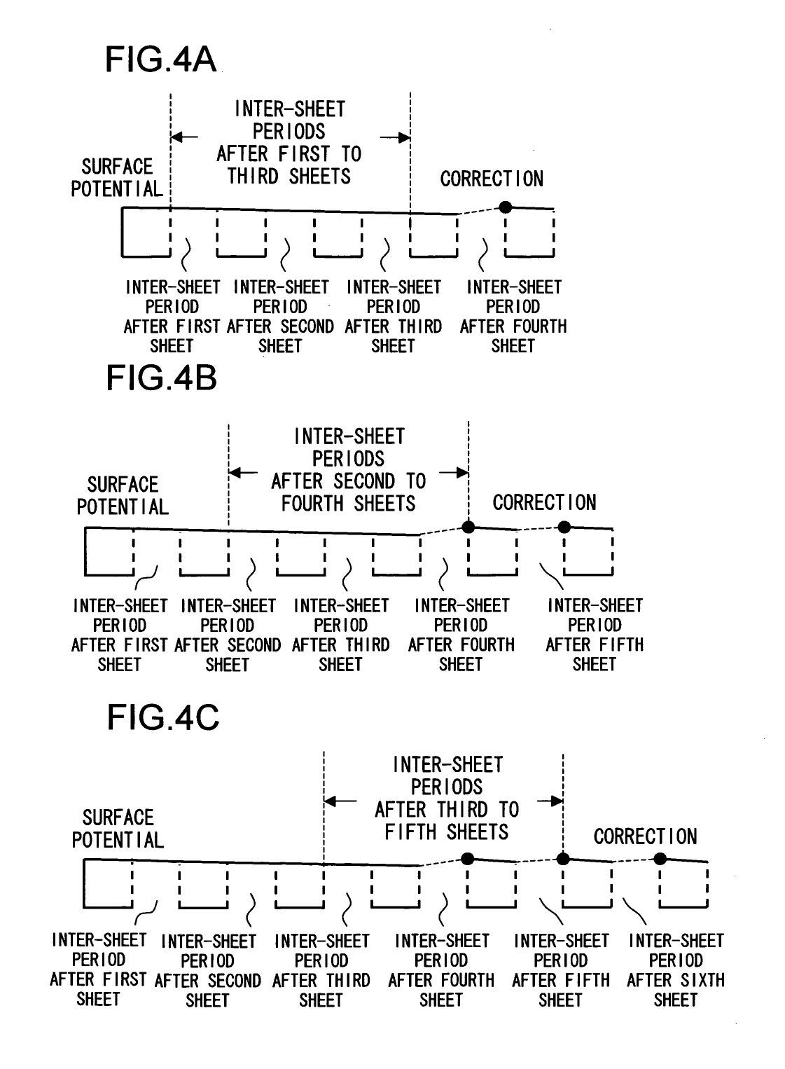

This can be improved by performing the first correction for every one-sheet-worth image formation based on the average of the surface potentials detected during the inter-sheet periods after a plurality of sheets. How such correction is controlled will be described below in detail with reference to FIGS. 4A, 4B and 4C. Here, it is assumed that the results of the surface potentials detected for three printed sheets are averaged. As shown in FIG. 4A, after the start of image formation until the fourth sheet is printed, only the surface potential is detected, and the first correction is not performed. Thus, the surface potential of the photoconductor drum gradually decreases.

During the inter-sheet period after the fourth sheet has been printed, the average of the surface potentials detected during the inter-sheet periods after the completion of the printing of the first to third sheets is calculated so that, based on the average thus calculated, the correction amount for the grid voltage, which is to be applied at the time of the printing of the fifth sheet, is determined with respect to the reference value G0. The surface potential is then increased by increasing the grid voltage by the correction amount at the time of the printing of the fifth sheet.

As shown in FIG. 4B, after the printing of the fifth sheet, as compared with the inter-sheet periods (after the first to third sheets) for which the average surface potential was calculated in FIG. 4A, they are shifted by one sheet so that the average of the surface potentials detected during the so shifted inter-sheet periods (after the second to fourth sheets) is calculated and, based on the average thus calculated, the correction amount for the grid voltage, which is to be applied at the time of the printing of the sixth sheet, is determined with respect to the reference value G0. Likewise, as shown in FIG. 4C, the grid voltage correction amount at the time of the printing of the seventh sheet is determined based on the average of the surface potentials detected during the inter-sheet periods after the completion of the printing of the third to fifth sheets.

In this way, based on the average of the surface potentials detected during the individual inter-sheet periods for the immediately preceding three sheets, the correction amount of the grid voltage with respect to the reference value is determined, and then, during the succeeding inter-sheet period, the grid voltage is increased by the correction amount. This makes it possible to accurately adjust the grid voltage to the optimal value for every one-sheet-worth image formation. It should be noted that, as the number of printed sheets increases, the surface potentials detected for the immediately preceding three sheets for which the average was calculated come to include more surface potentials that have been corrected. Thus, the absolute value of the correction amount decreases accordingly.

To determine the correction amount of the grid voltage from the average of surface potentials, a variation in the surface potential per unit variation in the grid voltage may be stored in the storage section 42 (for example, RAM 51 or ROM 52) so that, based on this amount, the control section 41 calculates the correction amount of the grid voltage at each time of printing. Alternatively, a correction table that provides grid voltage correction amounts corresponding to different averages of surface potentials may be previously stored in the storage section 42 (for example, RAM 51 or ROM 52) so that a correction amount corresponding to a given average of the surface potential is selected by use of the correction table at each time of printing.

The first correction is continuously performed until the completion of continuous image formation, or is finished when the resistance of the grid is so decreased during image formation that the surface potential stops decreasing. Instead of averaging the surface potentials detected during the inter-sheet periods for the immediately preceding three sheets, it is possible to average the detection results during the inter-sheet periods for the immediately preceding two or four or more sheets. Here, correction involving gradually increasing the grid voltage is so performed as to cope with both the decrease in the grid resistance attributable to the increase in the humidity inside the apparatus and with the associated decrease in the surface potential. With this, it is also possible to cope with a disadvantageous increase in the surface potential resulting from any cause. In this case, the gird voltage is decreased by a correction amount determined based on an average of surface potentials.

Referring back to FIG. 3A, after the completion of image formation, the resistance of the grid increases with a decrease in the humidity inside the apparatus so that the surface potential of the photoconductor drum 1 increases. Thus, the control section 41 performs the second correction whereby the grid voltage from G1 is gradually decreased to the initial value G0. The second correction is performed without the use of the surface potential sensor 44 so as to restore the grid voltage G1, which has been increased in the first correction, to the initial value G0 at predetermined time intervals ΔT within a predetermined period T. In this way, the increase of the grid voltage ΔG (=G1−G0) is restored to G0 at T/ΔT steps, and thus the correction amount of the grid voltage per unit time interval ΔT is represented by (G1−G0)·ΔT/T.

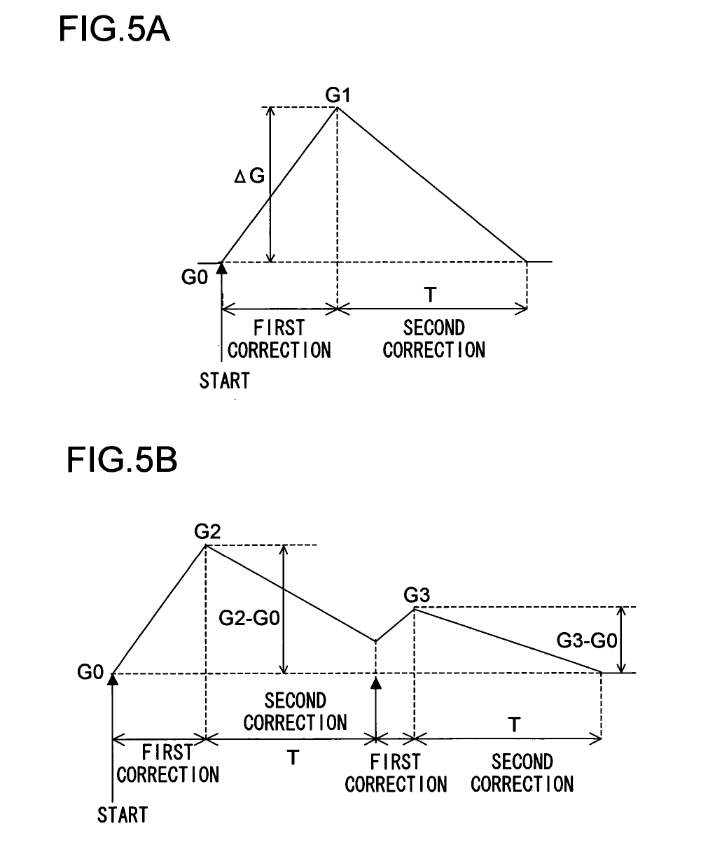

The performing period T of the second correction is determined depending on the specifications of an image forming apparatus, and varies with other factors such as use environment of the apparatus. Thus, it may be set through a simulation or the like. The shorter the correction time intervals ΔT are, the higher the correction accuracy becomes. Thus, as shown in FIGS. 5A and 5B, the grid voltage may be varied linearly instead, but even then it is usually so varied as not to impose an excessive burden on the control section 41. For example, assuming that the second correction period T is five minutes, and the correction time interval ΔT is thirty seconds, the grid voltage is restored from G1 to the initial value G0 at time intervals of thirty seconds in ten steps.

Next, a description will be given of a case where a next round of image formation is requested while the second correction is being performed. As shown in FIG. 3B, the grid voltage is assumed to be increased from G0 to G2 in the first correction during the first round of image formation. After the completion of the image formation, as in FIG. 3A, the second correction is performed to restore the grid voltage from G2 to the initial value G0. In this case, the correction amount of the grid voltage per unit time interval ΔT is represented by (G2−G0)·ΔT/T.

When a new round of image formation is requested while the grid voltage is being restored to the initial value G0, the control section 41 interrupts the second correction, then starts image formation, and performs the first correction to increase the grid voltage again. After the completion of the image formation, the second correction is performed anew to restore the grid voltage from a grid voltage G3 detected at the completion of image formation to the initial value G0 over the correction period T. In this case, the correction amount of the grid voltage per unit time interval ΔT is represented by (G3−G0)·ΔT/T.

Through the control described above, it is possible to perform correction accurately according to the surface potential so as to obtain images with proper density even when, after the completion of image formation, the surface potential has returned to its initial value or is in the middle of returning thereto due to a decrease in the humidity inside the apparatus. Even when the variation in the surface potential varies during image formation, with the only difference that the correction amount per unit time interval is varied accordingly in the second correction after the completion of the image formation, it is possible to restore the grid voltage to the initial value (reference value) over a predetermined period. Moreover, the surface potential is adjusted with predetermined timing such as when the power to the apparatus is turned on or when the apparatus is restored from a standby mode, and the grid voltage value at that point is stored as a reference value. Thus, it is possible to perform correction based on the newest reference value at all times.

Thus, even if the humidity environment around the apparatus changes with weather, the installation location of the apparatus, and the like, it is possible to form high-quality images stably. Although, in this example, the surface potential is adjusted by varying the grid voltage of the charger 2, it may be adjusted by varying the current through the main wire of the charger 2 instead of the grid voltage.

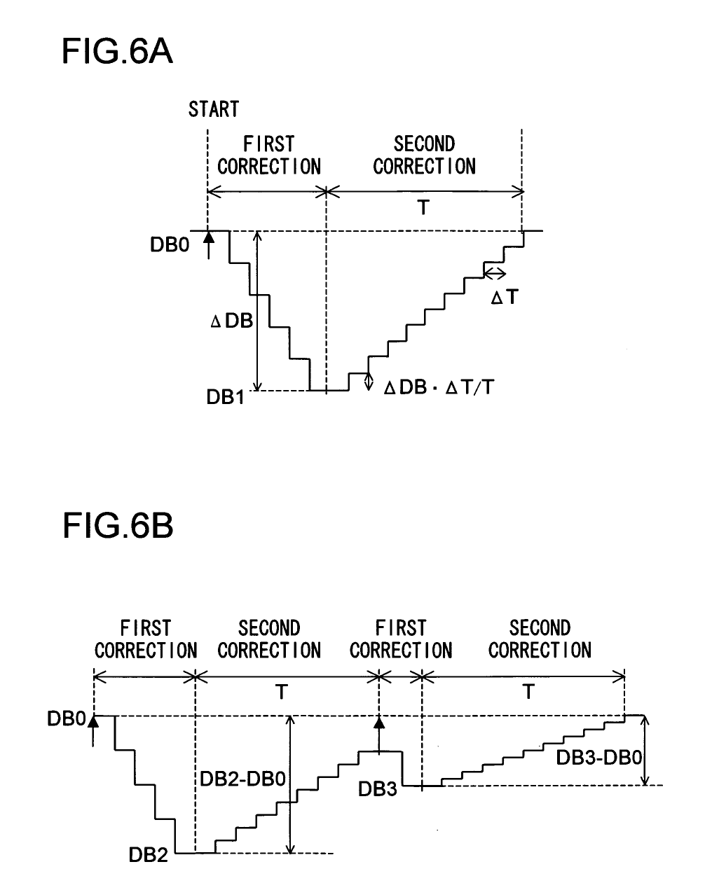

FIGS. 6A and 6B are timing charts showing another example of how the surface potential is corrected during continuous image formation and after the completion of the image formation in the image forming apparatus of the first embodiment. FIGS. 6A and 6B show a case where the developing potential of the developing sleeve 4a is adjusted by varying the direct current bias of the developing unit 4 instead of the grid voltage of the charger 2. To keep constant the potential difference between the surface potential of the photoconductor and the developing potential of the developing sleeve 4a, the correction of the direct current bias needs to be, in contrast to that of the grid voltage, performed by decreasing the direct current bias as the surface potential of the photoconductor decreases and by increasing it as the surface potential increases. As shown in FIG. 6A, as the humidity increases during image formation, the grid resistance decreases and thus the surface potential decreases. Thus, the first correction is so performed as to gradually decrease the direct current bias from the initial value DB0 to DB1. As the humidity decreases after the completion of the image formation, the grid resistance increases and thus the surface potential increases. Thus, the second correction is so performed as to gradually increase the direct current bias from DB1 to the initial value DB0.

The initial value DB0 is the direct current bias value as observed when the surface potential is adjusted, and is stored as a reference value in the storage section 42 as in the case of G0. It should be noted that how the correction period T and the time interval ΔT are set in the second correction, how correction is controlled when a new round of image formation is requested while the second correction is being performed, and the like are the same as described previously with reference to FIGS. 3A and 3B, and therefore no description thereof will be repeated. Although in this example, the developing voltage is adjusted by varying the direct current bias applied to the developing unit 4, the developing potential may be adjusted by varying the alternating current bias voltage applied to the developing unit 4 or the duty factor thereof.

When the direct current bias or the voltage and the duty factor of the alternating current bias applied to the developing unit 4 is corrected, based on the average of the surface potentials detected during the inter-sheet periods for a plurality of sheets as shown in FIGS. 4A to 4C, the correction amount for the next round of printing can be determined. Thus, it is possible to adjust the direct current bias, the alternating current bias voltage or the duty factor thereof to the optimal values more accurately for every one-sheet-worth image formation.

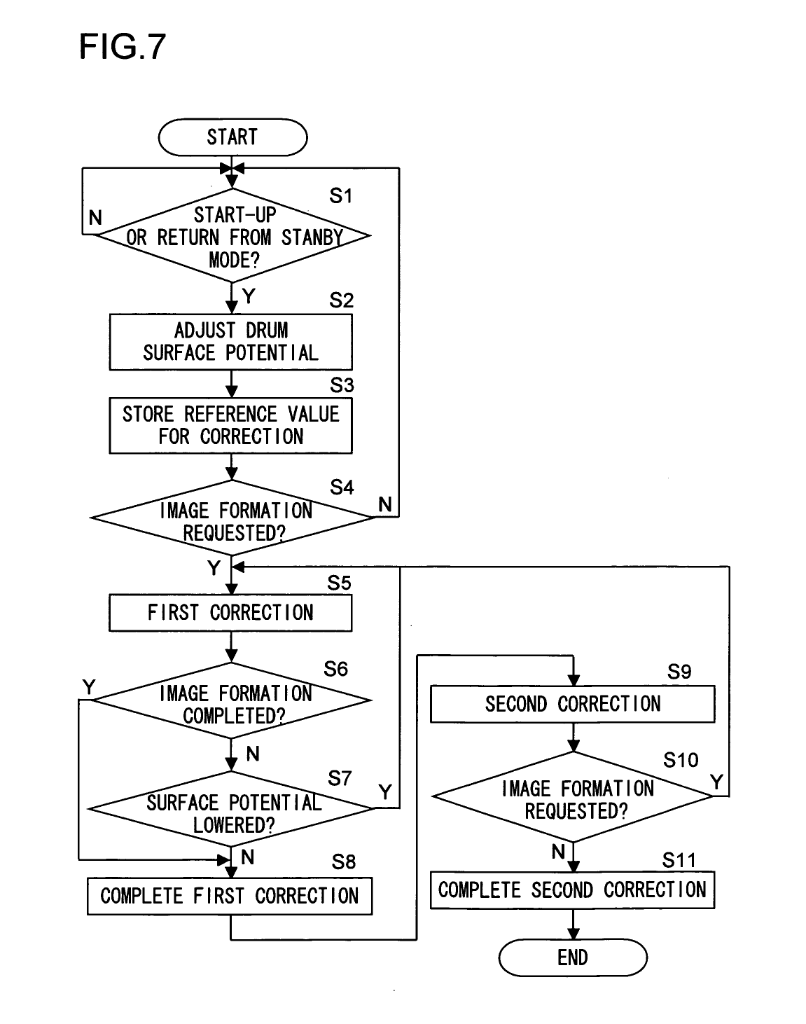

FIG. 7 is a flowchart showing how the image forming apparatus of the first embodiment operates. Now, the image forming process of the image forming apparatus will be described according to the steps shown in FIG. 7 with reference to FIGS. 1, 2, 3A and 3B. First, whether or not the power to the apparatus is turned on or the apparatus is restored from a standby mode is checked (step S1), and, if the power to the apparatus is turned on or the apparatus is restored from a standby mode, the surface potential sensor 44 detects the surface potential of the photoconductor drum 1 to adjust it based on the detection result (step S2). The ROM 51 included in the storage section 42 is then overwritten with the associated grid voltage (step S3).

Next, whether or not image formation is requested by a user is checked (step S4), and the operations from step S1 to step S3 are repeated until image formation is requested. When image formation is requested, the control section 41 converts an original image inputted in the image inputting section 20 into an image signal. The image signal is digitized into print data in the AD converting section 40, and is then stored in the image memory 50. Next, an image is formed on the photoconductor drum 1 based on the print data, and the formed toner image is then transferred to the sheet 11.

In parallel with this image formation, the surface potential sensor 44 continuously detects the surface potential of the photoconductor drum 1, and the control section 41 performs the first correction based on the detection result (step S5). Next, whether or not the image formation is completed is checked (step S6), and, if the image formation is still in progress, whether or not the surface potential decreases is checked (step S7). If the surface potential decreases, the process returns to step S5 and then the first correction is continuously performed. If the surface potential does not decrease, the first correction is completed (step S8) and then the remaining image formation is performed. If the image formation is completed in step S6, the first correction is completed (step S8).

After the completion of the image formation, the correction amount per unit time interval ΔG·ΔT/T is calculated from the difference ΔG between the grid voltage value G1 after the first correction and the reference value G0, the predetermined correction period T and the correction time intervals ΔT, and the second correction is performed (step S9). Then, whether or not a next round of image formation is requested is checked (step S10), and, if a next round of image formation is requested, then the second correction is interrupted and the process returns to step S5 to perform image formation and the first correction.

If no image formation is requested in step S10, the second correction is continuously performed. Then, when the grid voltage is restored to the reference value G0, the second correction is completed (step S11). Although the above description deals with a procedure for adjusting the surface potential through variation of the grid voltage, a similar procedure can be used when, as shown in FIGS. 6A and 6B, the developing potential is adjusted through variation of the developing bias.

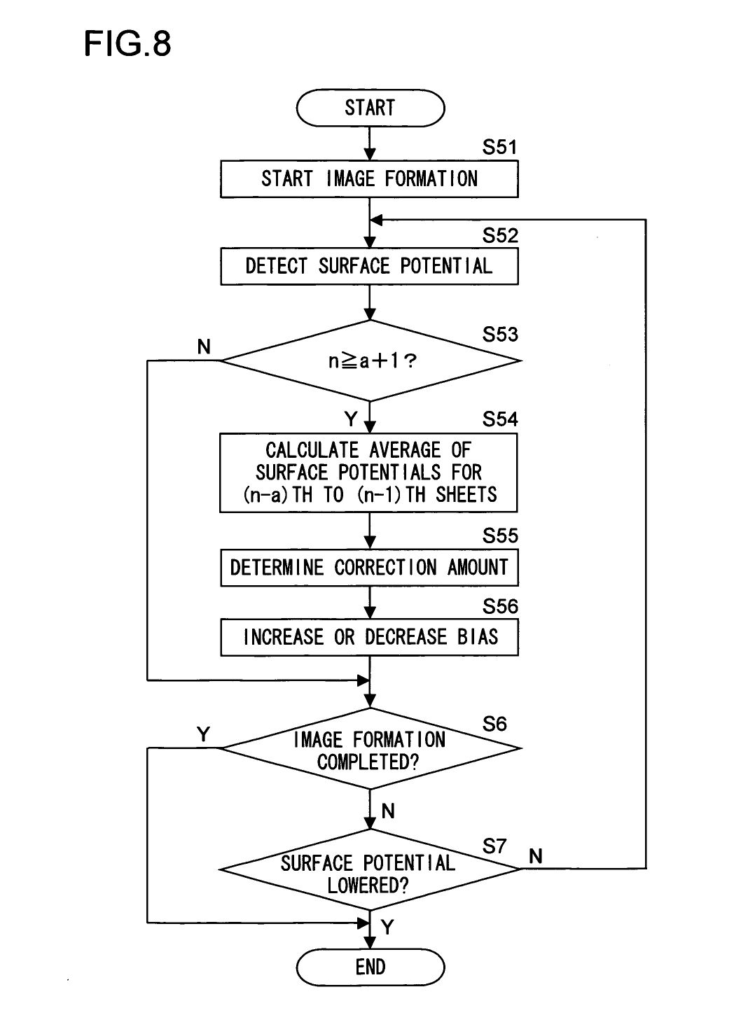

FIG. 8 is a flowchart showing the process of determining the correction amount based on the average of the surface potentials detected during the inter-sheet periods for a predetermined number of immediately preceding sheets, as shown in FIGS. 4A to 4C (corresponding to steps S5 to S7 in FIG. 7). Here, it is assumed that the correction amount is determined by averaging the surface potentials detected during the inter-sheet periods for a number “a” of immediately preceding sheets. First, when continuous printing is started (step S51), the surface potential sensor 44 detects the surface potential of the photoconductor drum during the inter-sheet periods after the completion of the printing of sheets (step S52). At the same time, the number n of printed sheets starts to be counted.

Next, whether or not the number n of printed sheets is equal to or more than a+1 is checked (step S53). If the number n of printed sheets is equal to or more than a+1, the average of the individual surface potentials detected for the number “a” of sheets starting with the (n−a)th sheet and ending with the (n−1)th sheet is calculated (step S54). Based on the calculated average value, the correction amount of the applied bias applied to the grid or the developing bias is determined (step S55), and the (n+1)th sheet is printed while the applied bias applied to the grid or the developing bias is increased or decreased by the determined correction amount (step S56).

Then, whether or not the image formation is completed is checked (step S6), and, if the image formation is still in progress, whether or not the surface potential decreases is checked (step S7). If the surface potential decreases, the process returns to step S52, where the surface potential during the inter-sheet periods is detected and, with one added to the number n of printed sheets, the first correction (steps S53 to S56) is continued. If the image formation is completed in step S6, or if the surface potential does not decrease in step S7, then the first correction is completed. If the number n of printed sheets is less than a+1 in step S53, the first correction is not performed because the average of the surface potential is not calculated, and then the process proceeds to step S6 and thereafter operations similar to those described above are performed (steps S6 to S7).

FIG. 9 is a block diagram showing the configuration of the image forming apparatus of a second embodiment of the present invention. Such parts as are found also in FIG. 2 are identified with common reference numerals. As compared with the image forming apparatus of the first embodiment, the image forming apparatus 100 here is provided with, instead of the surface potential sensor 44, a printed sheet counter 45 that counts the total number of printed sheets in the image forming section 15. In other respects, the configuration here is the same as in the first embodiment, and hence no description thereof will be repeated.

This embodiment is characterized in that, based on the total number of printed sheets as counted from the initial state of the apparatus by the printed sheet counter 45, the reference value is set for the adjustment of the surface potential of the photoconductor, and the first correction is performed based on a predetermined correction amount per unit number of sheets (unit period).

This makes it possible to adjust the surface potential of the photoconductor and to perform the first correction without the use of the expensive surface potential sensor 44. Advantageously, this reduces the cost of the apparatus. The reference value and the correction amount for the first correction are previously set through a simulation or the like without the need to measure the surface potential. This helps enhance processing efficiency and reduce the burden on the control section 41.

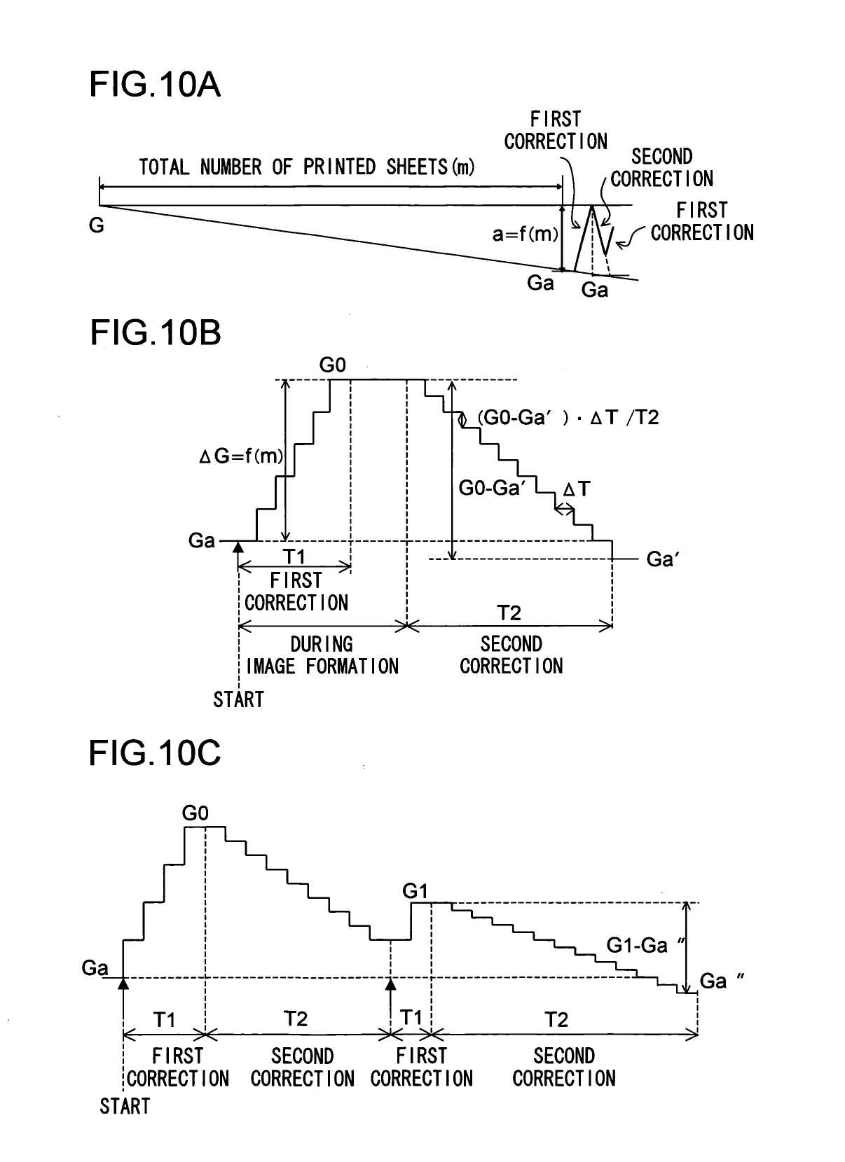

FIGS. 10A, 10B and 10C are timing charts showing how the surface potential is corrected during continuous image formation and after the completion of the image formation in the image forming apparatus of the second embodiment. How the correction is actually performed will be described more specifically with reference to FIGS. 9, 10A, 10B and 10C. Here, a description will be given of, as an example, a case where the surface potential is adjusted by varying the grid voltage of the charger 2.

Ga represents the reference value determined from the initially set value G0 of the grid voltage and the total number of printed sheets as counted from the initial state of the apparatus. As the total number m of printed sheets increases, the amount of attached discharge products increases and thus the grid resistance gradually increases. It is thus preferable to decrease the reference value from the initially set value G0 accordingly. Thus, as shown in FIG. 10A, by use of the initially set value G0 and a function f(m) of the total number m of printed sheets, according to Ga=G0−f(m), the reference values corresponding to the number of printed sheets are calculated, and are then stored as data in the storage section 42.

When image formation is requested, the total number of printed sheets is calculated from the count of the printed sheet counter 45, and the reference value Ga corresponding to the number of printed sheets is read from the reference value data stored in the storage section 42. When the image formation is actually started, the grid resistance decreases with an increase in humidity and thus the surface potential of the photoconductor drum 1 decreases. Thus, as shown in FIG. 10B, the control section 41 sets the correction amount per unit number of sheets (unit period) ΔG/T1 from the increase of the grid voltage ΔG(=G0−Ga) and the predetermined correction period T1 so as to perform the first correction whereby the grid voltage is gradually increased from Ga to G0.

The first correction may be performed for every one-sheet-worth image formation, or may be performed stepwise for each of a predetermined number of sheets. The first correction may be performed immediately after the start of image formation, or may be performed after the predetermined number of sheets have been printed. The first correction is completed when continuous image formation is finished, or when the grid voltage reaches the initially set value G0 during image formation.

After the completion of image formation, as the humidity inside the apparatus decreases again, the grid resistance increases and thus the surface potential of the photoconductor drum 1 increases. Hence, the control section 41 performs the second correction whereby the grid voltage is gradually decreased from G0 to the reference value Ga′. Here, the reference value Ga′ is a value that is read from the reference value data according to the total number of printed sheets as counted after the completion of the immediately preceding round of image formation (see FIG. 10A). The correction amount of the grid voltage per unit time interval ΔT is represented by ΔG′·ΔT/T2, where ΔG′ (=G0−Ga′) represents the decrease of the grid voltage, ΔT represents the correction time interval and T2 represents the correction period.

Next, a description will be given of a case where a next round of image formation is requested while the second correction is being performed. It should be noted that how the correction period T2 and the time interval ΔT for the second correction are set is the same as described previously with reference to FIGS. 3A and 3B, and hence no description thereof will be repeated. As shown in FIG. 10C, the grid voltage is assumed to be increased from Ga to G0 in the first correction during the first round of image formation. After the completion of the image formation, as the humidity inside the apparatus decreases again, the grid resistance increases and thus the surface potential of the photoconductor drum 1 increases. Thus, the control section 41 performs the second correction whereby the grid voltage is gradually decreased from G0 to Ga′.

When image formation is requested while the grid voltage is being restored to the reference value Ga′, the control section 41 interrupts the second correction, then starts the image formation, and performs the first correction whereby the gird voltage is increased again. After the completion of the image formation, the reference value Ga″ is read according to the total number of printed sheets as counted after the completion of the immediately preceding round of image formation, and then the second correction is so performed anew as to restore the grid voltage to the reference value Ga″ from G1 as observed at the completion of the image formation over the correction period T2. Here, the correction amount of the grid voltage per unit time interval ΔT is represented by ΔG″·ΔT/T2, where ΔG″ (=G1−Ga″) represents the decrease of the grid voltage, ΔT represents the correction time interval and T2 represents the correction period.

Through the control described above, it is possible to correct the surface potential accurately in consideration of temporal variations in the gird resistance that accompany the increase in the number of printed sheets. The correction is performed with the reference values that have previously been calculated through a simulation. This makes it possible to reduce the burden on the control section to allow rapid processing. Moreover, there is no need for the expensive surface potential sensor. Advantageously, this reduces the cost of the apparatus. Although in this example, the surface potential is adjusted by varying the grid voltage of the charger 2, it may be adjusted, as in the case of FIGS. 3A and 3B, by varying the current through the main wire of the charger 2 instead of the grid voltage.

The control described above applies quite equally to the case, as shown in FIGS. 6A and 6B, where the developing potential is adjusted by varying the direct current bias or the voltage and the duty factor of the alternating current bias applied to the developing unit 4. In this case, the reference values calculated from the initially set values of the direct current bias, the alternating current bias or the duty factor thereof and the total number of printed sheets are stored in the storage section 42 so that, as shown in FIGS. 10B and 10C, the first and second correction is performed with those values. Instead of the printed sheet counter 45, a printing time counter may be provided that calculates the total amount of printing time as measured from the initial state of the apparatus. This makes it possible to similarly perform the control by determining the reference values from the total amount of printing time.

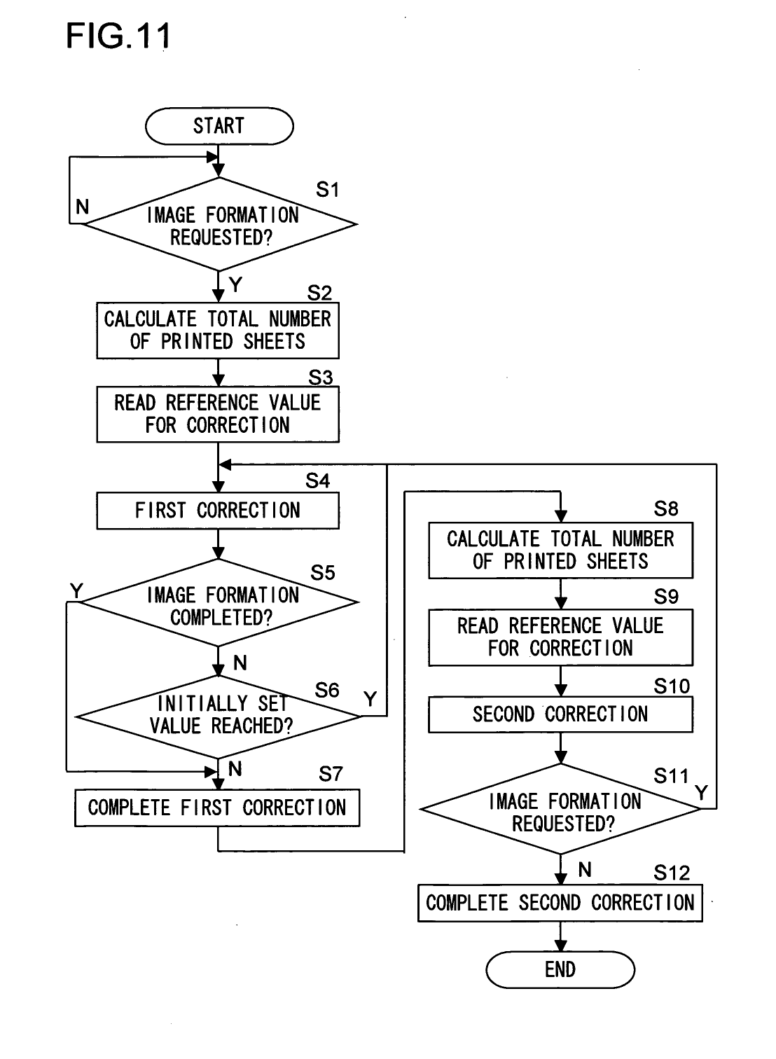

FIG. 11 is a flowchart showing how the image forming apparatus of the second embodiment operates. Now, the image forming process of the image forming apparatus will be described according to the steps shown in FIG. 11 with reference to FIGS. 1, 9, 10A, 10B and 10C. First, whether or not image formation is requested by a user is checked (step S1), and, if image formation is requested, the control section 41 calculates the total number of printed sheets from the count of the printed sheet counter 45 (step S2) and then reads the reference value Ga corresponding to the calculation result from the reference value data that has previously been stored in the storage section 42 (step S3).

The control section 41 converts an original image inputted in the image inputting section 20 into an image signal. The image signal is digitized into print data in the AD converting section 40, and is then stored in the image memory 50. Next, based on the print data, an image is formed on the photoconductor drum 1, and the formed toner image is then transferred to the sheet 11.

In parallel with this image formation, based on the reference value Ga read in step S3 and the grid voltage correction amount for each of a predetermined number of sheets (unit period), the control section 41 performs the first correction (step S4). Next, whether or not the image formation is completed is checked (step S5), and, if the image formation is still in progress, whether or not the grid voltage has reached the initially set value G0 is checked (step S6). If the grid voltage has not reached G0, the process returns to step S4 and then the first correction is continued, and, if the gird voltage has reached G0, the first correction is completed (step S7) and then the remaining image formation is performed. If the image formation is completed in step S5, the first correction is completed (step S7).

After the completion of the image formation, the total number of printed sheets is calculated anew by the printed sheet counter 45 (step S8) so that the reference value Ga′ corresponding to the calculation result is read from the reference value data that has previously been stored in the storage section 42 (step S9). The correction amount per unit time interval ΔG′·ΔT/T is calculated from the difference ΔG′ between the grid voltage value G1 as observed after the first correction and the reference value Ga′ as observed after the completion of the image formation, the predetermined correction period T and the correction time interval ΔT, and the second correction is performed (step S10).

Then, whether or not a next round of image formation is requested is checked (step S11), and, if a new round of image formation is requested, the second correction is interrupted and the process returns to step S4 to perform the image formation and the first correction. If no image formation is requested in step S11, the second correction is continued and the grid voltage is then restored to the reference value Ga′. Then, the second correction is completed (step S12).

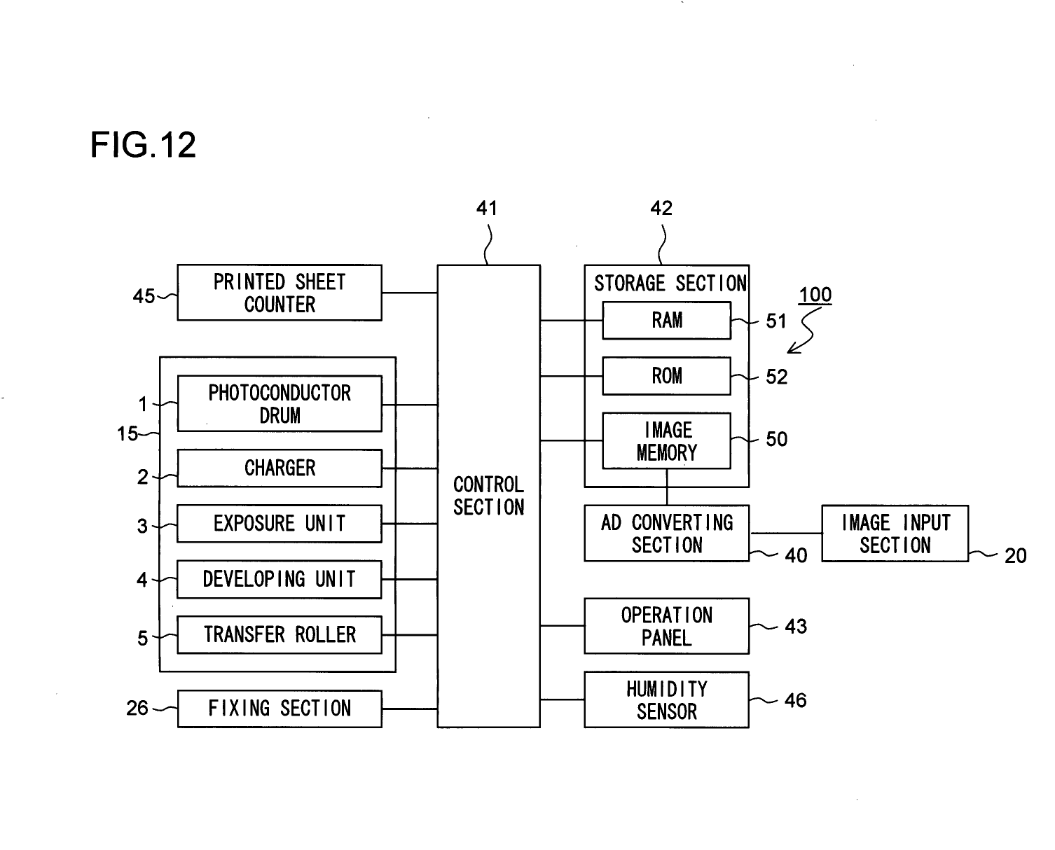

FIG. 12 is a block diagram showing the configuration of the image forming apparatus of a third embodiment of the present invention. Such parts as are found also in FIGS. 2 and 9 are identified with common reference numerals. As compared with the image forming apparatus of the second embodiment, the image forming apparatus 100 shown in FIG. 12 is additionally provided with a humidity sensor 46 that detects the humidity inside the apparatus. In other respects, the configuration here is the same as in the second embodiment, and hence no description thereof will be repeated.

This embodiment is characterized in that the humidity sensor 46 detects the humidity inside the apparatus so that the correction amount per unit period in the first correction and the correction period in the second correction are adjusted according to the detection result. As the humidity inside the apparatus changes with weather, use environment of the apparatus and the like, the speed at which the discharge products attached to the grid dissolve and the speed at which they turn back non-conductive vary. Thus, the speed at which the surface potential of the photoconductor decreases during continuous image formation and the speed at which the surface potential of the photoconductor increases after the completion of the image formation vary.

With the image forming apparatus of this embodiment, by feeding variations in the humidity inside the apparatus back to the bias correction amount in the first correction, it is possible to perform the correction with respect to variations in the surface potential more accurately. This makes it possible to form high-quality images stably. By feeding variations in the humidity inside the apparatus back to the correction period in the second correction, it is also possible to enhance the accuracy of the surface potential for the immediately succeeding round of printing.

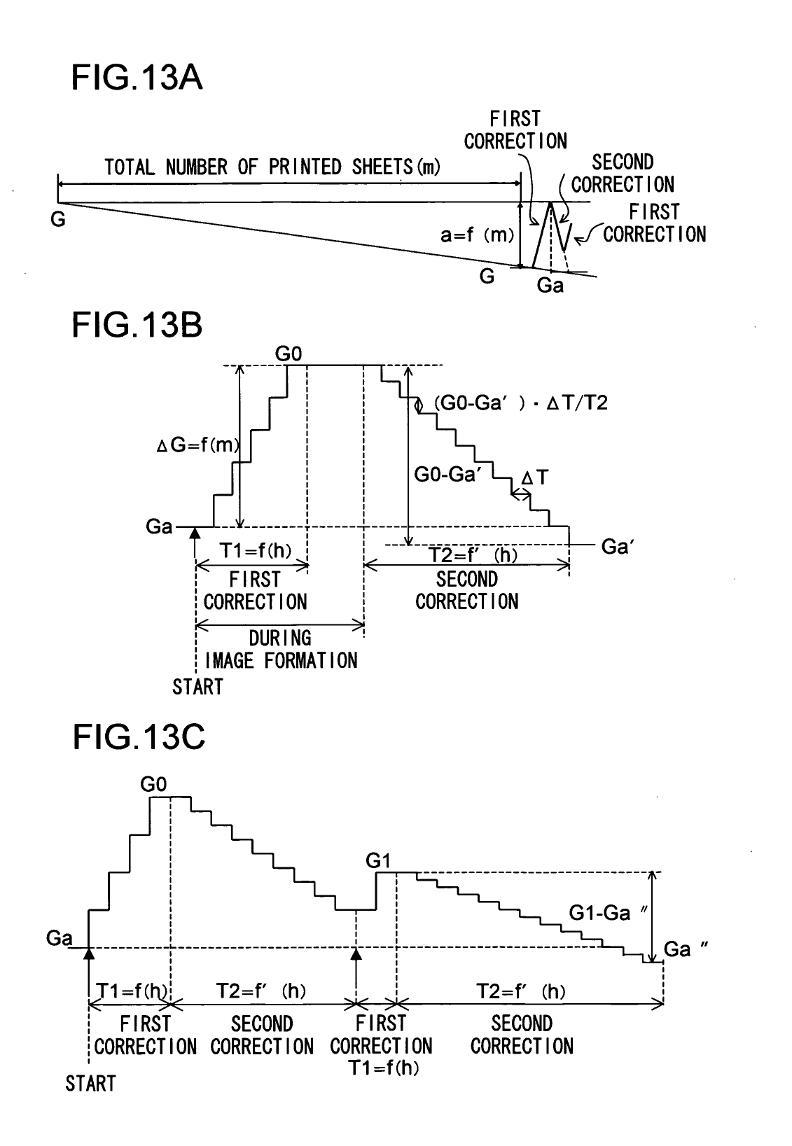

FIGS. 13A, 13B and 13C are timing charts showing how the surface potential is corrected during continuous image formation and after the completion of the image formation in the image forming apparatus of the third embodiment. Here, a description will be given of, as an example, a case where the surface potential is adjusted by varying the grid voltage of the charger 2. It should be noted that how the reference values Ga, Ga′ and Ga″ are determined and how the first and second correction is performed as shown in FIG. 13A are the same as described previously in connection with the second embodiment shown in FIG. 10A, and hence no description thereof will be repeated; thus, the following description only discusses differences from the second embodiment.

As shown in FIG. 13B, the control section 41 performs the first correction whereby the grid voltage is increased from Ga to G0 over the correction period T1. Here, the correction amount for each of a predetermined number of sheets (unit period) is represented by ΔG/T1, where ΔG (=G0−Ga) represents the increase of the grid voltage and T1 represents the correction period. Here, let the humidity inside the apparatus be h, then, as h increases, the speed at which the discharge products attached to the grid dissolve increases and thus the speed at which the grid resistance decreases increases. It is, thus, preferable to increase the correction amount per unit period ΔG/T1 accordingly.

Thus, by use of a function of humidity f(h), according to T1=f(h), the correction period T1 corresponding to the humidity inside the apparatus is calculated, and is then stored as data in the storage section 42. At the time of the first correction, the humidity inside the apparatus is detected by the humidity sensor 46. Thus, the correction amount ΔG/T1 is calculated from the correction period T1 that is read according to the detection result, and the first correction is performed.

After the completion of the image formation, the grid voltage is restored from G0 to the reference value Ga′ over the correction period T2. Here, the correction amount of the grid voltage per unit time interval ΔT is represented by ΔG′·ΔT/T2, where ΔG′ (=G0−Ga′) represents the decrease of the grid voltage, ΔT represents the correction time interval and T2 represents the correction period. As the humidity h inside the apparatus increases, the speed at which the discharge products attached to the grid turn back non-conductive decreases and thus the speed at which the grid resistance increases decreases. It is, thus, preferable to decrease the correction amount per unit time interval ΔG′·ΔT/T2 accordingly.

Thus, as with the correction period T1, by use of a function of humidity f′(h), according to T2=f(h), the correction period T2 corresponding to the humidity inside the apparatus is calculated, and is stored as data in the storage section 42. At the time of the second correction, the humidity inside the apparatus is detected by the humidity sensor 46. Thus, the second correction is performed based on the correction period T2 that is read according to the detection result.

When image formation is requested while the grid voltage is being restored to the reference value Ga′, the control section 41 interrupts the second correction as shown in FIG. 13C, then starts the image formation, and performs, based on the correction period T1 calculated from T1=f(h), the first correction whereby the gird voltage is increased again. After the completion of the image formation, based on the correction period T2 calculated from T2=f′(h), the second correction is so performed anew as to restore the grid voltage from G1 as observed at the completion of the image formation to the reference value Ga″ over the correction period T2.

Through the control described above, as in the second embodiment, it is possible to correct the surface potential quickly and accurately based on the reference value calculated in consideration of temporal variations in the grid resistance that accompany the increase in the number of printed sheets, and there is no need for the expensive surface potential sensor. Moreover, this makes it possible to correct the surface potential according to variations in the humidity inside the apparatus. This helps enhance the accuracy of the surface potential at the start of printing and the accuracy of the correction in the first and second correction.

Although in this example, the surface potential is adjusted by varying the grid voltage of the charger 2, it may be adjusted, as in the case of FIGS. 3A and 3B, by varying the current through the main wire of the charger 2 instead of the grid voltage. The control described above applies quite equally to the case where the developing potential is adjusted by varying the voltage of the direct current bias or the voltage and the duty factor of the alternating current bias applied to the developing unit 4 as shown in FIG. 6.

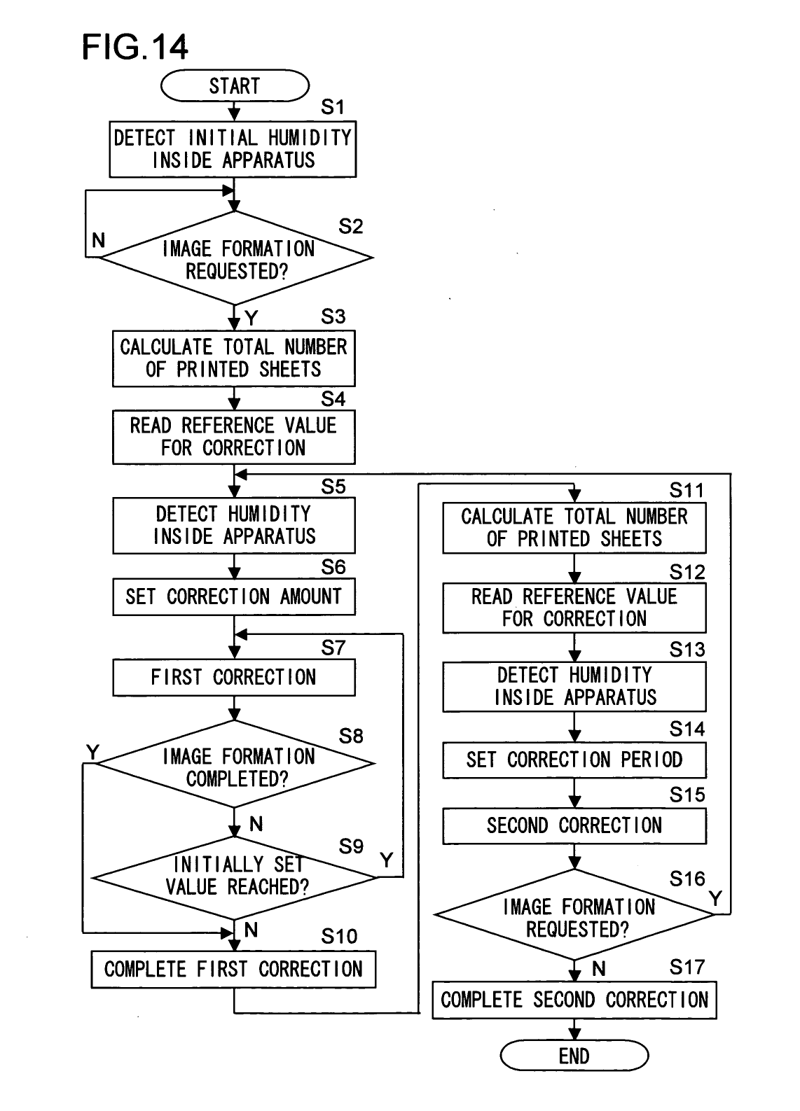

FIG. 14 is a flowchart showing how the image forming apparatus of the third embodiment operates. Now, the image forming process of the image forming apparatus will be described according to the steps shown in FIG. 14 with reference to FIGS. 1, 12, 13A, 13B and 13C. First, the humidity inside the apparatus is detected with the humidity sensor 46 (step S1), and the humidity thus detected is stored as an initial humidity in the storage section 42. Next, whether or not image formation is requested by a user is checked (step S2), and, if image formation is requested, the total number of printed sheets is calculated by the printed sheet counter 45 (step S3) and then the control section 41 reads the reference value Ga corresponding to the calculation result from the reference value data that has previously been stored in the storage section 42 (step S4).

The humidity inside the apparatus is detected anew with the humidity sensor 46 (step S5) so that, based on the difference between the humidity detected in step S5 and the initial humidity detected in step S1, the correction period T1 is calculated. Thus, the grid voltage correction amount for each of a predetermined number of sheets (unit period) ΔG/T1 is set based on the difference ΔG between the reference value Ga and the correction target value (initially set value) G0 and the correction period T1 (step S6). The control section 41 converts an original image inputted in the image inputting section 20 into an image signal. The image signal is digitized into print data in the AD converting section 40. Next, based on the print data, an image is formed on the photoconductor drum 1, and the formed toner image is then transferred to the sheet 11.

In parallel with this image formation, based on the reference value Ga read in step S4 and the grid voltage correction amount set in step S6, the control section 41 performs the first correction (step S7). Next, whether or not the image formation is completed is checked (step S8), and, if the image formation is still in progress, whether or not the grid voltage has reached the initially set value G0 is checked (step S9). If the grid voltage has not reached G0, the process returns to step S7 and then the first correction is continued, and, if the gird voltage has reached G0, the first correction is completed (step S10) and then the remaining image formation is performed. If the image formation is completed in step S8, the first correction is completed (step S10).

After the completion of the image formation, the total number of printed sheets is calculated anew by the printed sheet counter 45 (step S11) so that the reference value Ga′ corresponding to the calculation result is read from the reference value data that has previously been stored in the storage section 42 (step S12). The humidity sensor 46 detects the humidity inside the apparatus (step S13) so that, based on the difference between the humidity detected in step S13 and the initial humidity, the correction period T2 is calculated (step S14). The correction amount per unit time interval ΔG′·ΔT/T2 is calculated from the difference ΔG′ between the grid voltage value G1 as observed after the first correction and the reference value Ga′ read in step S12 at the completion of the image formation, the correction period T2 calculated in step S14 and the predetermined correction time interval ΔT, and the second correction is performed (step S15).

Then, whether or not a next round of image formation is requested is checked (step S16), and, if a new round of image formation is requested, the second correction is interrupted and the process returns to step S7 to perform the image formation and the first correction. If no image formation is requested in step S16, the second correction is continued and the grid voltage is then restored to the reference value Ga′. Then, the second correction is completed (step S17).

Although the correction is performed by feeding variations in the humidity back both to the gird voltage correction amount ΔG/T1 in the first correction and to the correction period T2 in the second correction, the correction may be performed in consideration of variations in the humidity with respect to only one of the gird voltage correction amount ΔG/T1 and the correction period T2. In this case, it is preferable to correct only the grid voltage correction amount ΔG/T1 that greatly affects the quality of printed image.

The present invention is not limited to the embodiments specifically described above, and various modifications and variations can be made without departing from the sprit of the present invention. For example, although in the first embodiment, the surface potential is adjusted when the power to the apparatus is turned on or when the apparatus is restored from a standby mode, the present invention is not limited to such a configuration. For example, in the first embodiment shown in FIG. 2, a printed sheet counter 45 may be further provided so that the surface potential is adjusted for each of a predetermined number of printed sheets.

In the embodiments described above, either the applied bias of the charger such as the grid voltage or the current through the main wire applied to the charger, or the developing bias such as the direct current bias or the alternating current bias and the duty factor thereof applied to the developing unit is adjusted so as to correct the surface potential or the developing potential. Alternatively, the present invention may be practiced with a configuration in which both the applied bias of the charger and the developing bias of the developing unit are adjusted.

As an example of an image forming apparatus according to the present invention, a digital multifunctional apparatus as shown in FIG. 1 has been discussed. It should however be understood that the present invention is equally applicable to tandem-type color image forming apparatuses, analog monochrome image forming apparatuses and other image forming apparatuses such as facsimiles or printers.

According to the present invention, an image forming apparatus is provided with an image forming section and control means. The image forming section includes: a photoconductor; a scorotron-type charger that evenly charges the surface of the photoconductor; an exposure unit that writes an electrostatic latent image on the surface of the photoconductor; and a developing unit that attaches toner to the surface of the photoconductor by use of a developer carrying member to form a toner image according to the electrostatic latent image. The control means varies the potential difference between the surface potential of the photoconductor and the developing potential of the developer carrying member by adjusting at least one of the applied bias of the charger and the developing bias of the developer carrying member. In this image forming apparatus, the control means performs first correction whereby at least one of the applied bias and the developing bias is corrected from a predetermined reference value so as to keep the potential difference constant during continuous image formation, and also performs second correction whereby the bias corrected in the first correction is restored to the reference value over a predetermined period after the completion of the continuous image formation.

With the construction described above, it is possible to keep constant the potential difference between the surface potential of the photoconductor and the developing potential of the developer carrying member through the first correction during continuous image formation, and also to keep the potential difference constant through the second correction even if the discharge products attached to the grid turn back non-conductive as the humidity decreases after the completion of the image formation and thus the surface potential of the photoconductor returns to the value thereof as observed before the image formation. This makes it possible to realize an image forming apparatus that can provide high-quality images at all times.

By additionally providing a surface potential detecting means that detects the surface potential of the photoconductor, it is possible to set the reference value corresponding to the actually measured value of the surface potential even if the humidity environment around the apparatus changes with weather, the installation location of the apparatus and the like. Thus, it is possible to perform the first correction effectively based on the actually measured value of the surface potential during continuous printing. Moreover, by adopting a construction in which, based on the average of the surface potentials detected during inter-sheet periods for a predetermined number of printed sheets, the correction amount relative to the reference value is determined so that the correction is performed whereby at least one of the applied bias and the developing bias is increased or decreased by the correction amount during the inter-sheet periods, it is possible to perform the first correction accurately for every one-sheet-worth image formation. This makes it possible to realize an image forming apparatus that can form higher-quality images.

By setting the reference value based on the number of printed sheets as counted from the initial state of the apparatus, it is possible to set the reference value without the use of the surface potential detecting means in consideration of temporal variations in the grid resistance that accompany an increase in the number of printed sheets. This helps reduce the burden on the control section so as to allow rapid processing. Furthermore, by determining the correction amount per unit period in the first correction and the performing period in the second correction based on both the number of printed sheets as counted from the initial state of the apparatus and variations in the humidity inside the apparatus, it is possible to correct the surface potential more accurately with respect to variations in the surface potential and also to further enhance the accuracy of the surface potential or the developing potential for the succeeding round of printing even if the humidity environment around the apparatus changes with weather, the installation location of the apparatus and the like. This makes it possible to realize an image forming apparatus that can form higher-quality images stably.

When a next round of image formation is requested while the second correction is being performed, the second correction is interrupted and then the image forming process and the first correction are performed. Then, after the completion of the image formation, the second correction is performed anew. Thus, it is possible to perform the correction accurately even when the surface potential of the photoconductor is in the middle of returning to the value thereof as observed before the image formation.

What is claimed is:

1. An image forming apparatus comprising:
an image forming section including:
a photoconductor;
a scorotron-type charger that evenly charges a surface of the photoconductor;
an exposure unit that writes an electrostatic latent image on the surface of the photoconductor; and
a developing unit that attaches toner to the surface of the photoconductor by use of a developer carrying member and that thereby forms a toner image according to the electrostatic latent image, and
control means that varies a potential difference between a surface potential of the photoconductor and a developing potential of the developer carrying member by performing potential adjustment of at least one of an applied bias of the charger and a developing bias of the developer carrying member, wherein
the control means performs first correction whereby at least one of the applied bias and the developing bias is corrected from a predetermined reference value so as to keep the potential difference constant during continuous image formation, and performs second correction whereby the bias corrected in the first correction is restored to the reference value over a predetermined period after completion of the continuous image formation.

2. The image forming apparatus of claim 1, further comprising: surface potential detecting means that detects the surface potential of the photoconductor,
wherein the control section performs the potential adjustment to set the reference value with predetermined timing based on a detection result of the surface potential detecting means and also performs the first correction based on the detection result of the surface potential detecting means as detected during continuous image formation.

3. The image forming apparatus of claim 2, wherein
the first correction involves determining a correction amount relative to the reference value based on an average of surface potentials of the photoconductor as detected during inter-sheet periods for a predetermined number of sheets and then increasing or decreasing at least one of the applied bias and the developing bias by the correction amount.

4. The image forming apparatus of claim 3, wherein
the first correction is performed during inter-sheet periods after inter-sheet periods for a predetermined number of sheets have elapsed after continuous image formation was started until the continuous image formation is completed or until the surface potential of the photoconductor stops varying.

5. The image forming apparatus of claim 2, wherein
the control means performs the potential adjustment at start-up or on return from a standby mode, and also performs the second correction such that the bias corrected in the first correction is restored to the reference value as set in the immediately preceding potential adjustment.

6. The image forming apparatus of claim 1, further comprising: printed sheet counting means that counts a total number of printed sheets,
wherein the reference value is set for at least one of the applied bias and the developing bias based on an initially set value thereof and a number of printed sheets as counted from an initial state of the apparatus.

7. The image forming apparatus of claim 6, wherein
the control means completes the first correction when the applied bias or the developing bias reaches the initially set value thereof during image formation.

8. The image forming apparatus of claim 6, further comprising: humidity detecting means that detects humidity inside the apparatus,
wherein, based on the number of printed sheets as counted from the initial state of the apparatus and a detection result of the humidity detecting means, at least one of a correction amount per unit period in the first correction and a period for which to perform the second correction is determined.

9. The image forming apparatus of claim 1, wherein,
when a next round of image formation is requested before completion of the second correction, the control means interrupts the second correction and then performs image formation and the first correction.
